(19) United States
(12) Patent Application Publication
(10) Pub. No.: US 2024/0340599 A1
(43) Pub. Date: Oct. 10, 2024

(54) HEARING ASSIST DEVICE

(71) Applicant: BESREV LLC, North Reading, MA (US)

(72) Inventors: Avi Nelson, North Reading, MA (US); Angelo Tortola, Lexington, MA (US)

(21) Appl. No.: 18/626,934

(22) Filed: Apr. 4, 2024

Related U.S. Application Data
(60) Provisional application No. 63/457,267, filed on Apr. 5, 2023.

(51) Int. Cl. H04R 25/00

(52) U.S. Cl. CPC H04R 25/40

(57) ABSTRACT

A hearing assist device enhances the voice of a speaker and provides an amplified version of the speaker's voice presented to a listener. The device comprises a detector which preferentially receives voice sounds from a speaker and which detector has at least one microphone for receiving the voice sounds and producing a signal representation thereof. The detector may comprise a tube having an input end which receives the voice sounds and at an output end of the tube which detector provides a signal representation of the voice sounds to an amplifier which in turn drives a loudspeaker.

### CROSS REFERENCE TO RELATED APPLICATION

This application claims priority to U.S. Provisional Application No. 63/457,267; filed on Apr. 5, 2023, entitled HEARING ASSIST DEVICE which is incorporated herein by reference.

### BACKGROUND OF THE INVENTION

A frequent problem in restaurants and other establishments is the difficulty of hearing someone sitting across a table when engaging in ordinary conversation or of hearing the server speaking in a restaurant. This is especially acute if there is significant background noise, or the speaker has a soft voice.

### SUMMARY OF THE INVENTION

Accordingly, one object of this invention is a hearing assist device which enhances the voice of a speaker and provides an amplified version of the speaker's voice presented to a listener. The device comprises a detector which preferentially receives voice sounds from a speaker and which has at least one microphone for receiving the voice sounds and producing a signal representation thereof. In one embodiment, the detector comprises a tube having an input end which receives the voice sounds and at an output end of the tube which provides a signal representation of the voices sounds to an amplifier which drives a loudspeaker. The device is housed in a convenient sized package that can be placed on the table in front of the listener or on the listener's lap and directed toward the speaker whose voice needs amplification. The tube can be of relatively short length and small diameter which partially filters the ambient sound by selectively favoring sound that propagates along the axis of the tube. In one embodiment, the receiving end of the tube is a paraboloid such that the parallel sound waves traveling through the tube are reflected off the paraboloid surface to a focal point where a microphone is situated. In one version the tube is angled upward to a fixed angle to the mouth of the speaker, in another version the tube angle is adjustable. An amplifier adjustably amplifies the speaker's voice, and the amplified sound signal is broadcast via a loudspeaker toward the listener. This sound signal now has a larger component of the speaker so that the voice is more prominent relative to the background noise thereby facilitating communication and conversation. The loudspeaker output volume can be varied by a conventional control means such as a knob or slider associated with the amplifier. The sound volume can thus be adjusted by the listener to accommodate preference and ambient sound conditions. There can be variation in all the parameters; namely, tube length, tube diameter, tube angle, amplifier output, loudspeaker size, or loudspeaker orifice. The tube cross section may be circular but need not be. The device can be constructed in various and different configurations for different applications.

In one embodiment, the loudspeaker may be recessed behind a flared or horn like orifice which directs the output sound. In one version since the paraboloid reflects parallel soundwaves to a focal point, there is no need for a tube in this version. Illustrative embodiments are shown in the accompanying drawings.

### DESCRIPTIONS OF THE DRAWINGS

FIG. 1 is a diagrammatic representation of one embodiment having a tube with a paraboloidal end and a microphone located at the focal point of the paraboloid;

FIG. 2 is an embodiment having a paraboloidal receiving surface with a microphone at the focal point but with no tube;

FIG. 3 is an embodiment having an open tube without a paraboloid;

FIG. 4 is a cross sectional representation of a material which may be of sheet or block form having an array of parallel channels or openings through the material which offer preferential transmission of sound longitudinal to those channels; and

FIG. 5 is an embodiment having a directional microphone without a tube.

### DETAILED DESCRIPTION OF THE INVENTION

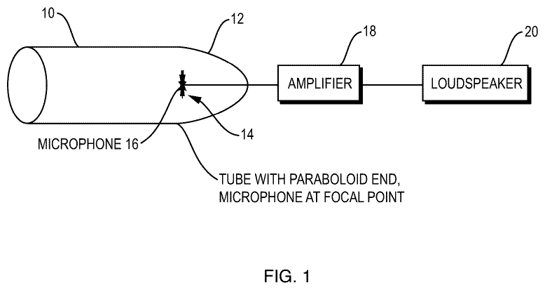

Referring to FIG. 1, there is shown one embodiment of the hearing assist device which includes a hollow tube 10 having a paraboloidal inner end 12 which has a focal point 14 at which a microphone 16 is disposed. The microphone is connected to an audio amplifier 18, well known in the art, the output of which is connected to a loudspeaker 20 (also known in the art) which provides an amplified sound output to a listener. In operation, the vocal sounds of a speaker are directed down the tube 10 and received by microphone 16 which provides a signal representation of the speaker's voice to amplifier 18 which provides an amplified voice signal to loudspeaker 20. In a variation of this embodiment, the tube may be an open tube with a microphone at either end thereof without a paraboloid at either end. The microphone may preferably be a directional microphone to preferentially receive sound travelling along the tube.

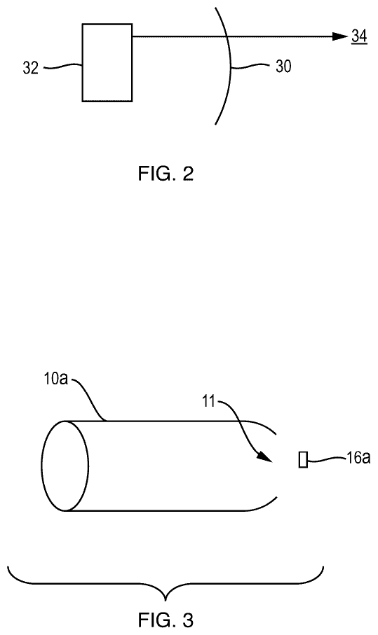

FIG. 2 shows an embodiment without a tube such as tube 10 in FIG. 1 which has a paraboloidal reflector 30 at the focal point of which is disposed a microphone 32. The microphone is connected as in FIG. 1 to an amplifier 18 which in turn is connected to a loudspeaker 20. In the embodiment of FIG. 2 is the sound from a speaker is preferentially directed to the paraboloid 30 which focuses the sound toward the microphone 32 which provides a signal representation 34 of the speaker's voice to amplifier 18 and then to loudspeaker 20.

In the embodiment of FIG. 3, an open tube 10a which can be similar to that of FIG. 1 does not have a paraboloidal inner end but rather an open end 11. A microphone 16a is positioned at the inner open end 11 to receive sounds propagating along the tube 10a.

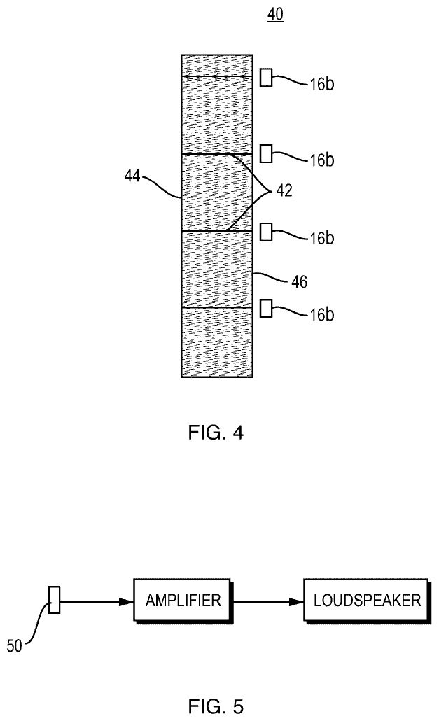

In a further embodiment shown in FIG. 4, an array or plurality of channels can be provided through a sheet or block of material to provide the tube which preferentially transmits sounds emanating from a speaker's voice. This is illustrated in FIG. 4 which shows a block 40 of material through which an array of channels 42 are provided from the front surface 44 to the back surface 46. One or more microphones 16b can be provided at or on the back surface of each of the channels 42 and collectively the microphones are coupled to an amplifier and loudspeaker as described with the previous embodiments.

FIG. 5 shows a version which has no tube, and which uses a directional microphone 50 to receive voice signals from a speaker. The microphone, which per se is known, preferentially receives sounds along an intended axis which in this case is an axis from the speaker's mouth and the microphone input. The microphone 50 is coupled to an amplifier and loudspeaker as described with the previous embodiments.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

1. A hearing assist device comprising:
a detector which preferentially receives voice sounds from a speaker, the detector having at least one microphone for receiving the voice sounds and producing signal representations thereof;
an audio amplifier coupled to the at least one microphone and operative to amplify the signal representations of the voice sounds; and
a loudspeaker coupled to the amplifier and operative to provide an amplified version of the voice sounds.

2. The hearing assist device of claim 1, wherein the detector includes a hollow tube having an open input end positioned to receive voice sounds from the speaker, and having a microphone at the output end of the tube positioned to receive voice sounds propagating through the tube.

3. The hearing assist device of claim 2, wherein the tube at its output end is connected to a paraboloid having a surface for focusing the sound waves to a focal point at which the microphone is disposed.

4. The hearing assist device of claim 1, wherein the detector includes a paraboloid having a paraboloidal surface operative to focus voice sounds incident thereon to a focal point at which a microphone is disposed.

5. The hearing assist device of claim 1, wherein the detector includes a block of material having a plurality of channels therethrough the input end of the channels receiving voice sounds from the speaker and the output end of the channels each coupled to a microphone, the microphones being coupled to the audio amplifier.

6. The hearing assist device of claim 1, wherein the detector is a directional microphone positioned to receive voice sounds from a speaker and provide a signal representation of the voice sounds.
